(19) United States
(12) Patent Application Publication
(10) Pub. No.: US 2026/0184013 A1
(43) Pub. Date: Jul. 2, 2026

(54) Extruder Nozzle and 3D Printing Device Using the Same

(71) Applicant: Shenzhen Creality 3D Technology Co., Ltd., Shenzhen (CN)

(72) Inventors: Dajiang WU, Shenzhen (CN); Weizhen LI, Shenzhen (CN); Zhiwei LIU, Shenzhen (CN); Jingke TANG, Shenzhen (CN)

(21) Appl. No.: 19/372,578

(22) Filed: Oct. 29, 2025

(30) Foreign Application Priority Data
Dec. 31, 2024 (CN) 202411998864.7

(51) Int. Cl. B29C 64/209; B29C 48/02; B29C 48/86; B29C 48/87; B29C 64/245; B33Y 30/00

(52) U.S. Cl. CPC B29C 64/209; B29C 48/02; B29C 48/865; B29C 48/87; B29C 64/245; B33Y 30/00

(57) ABSTRACT

This application provides an extruder nozzle and a 3D printing device using the same. The extruder nozzle includes a transmission channel, a nozzle assembly, a heat dissipation assembly, and a mounting assembly. The transmission channel includes an upstream portion and a downstream portion arranged along the first direction. The nozzle assembly is thermally coupled with the downstream portion and is configured to heat the consumable material. The heat dissipation assembly is spaced apart from the nozzle assembly along the first direction, with a part of the transmission channel arranged between the nozzle assembly and the heat dissipation assembly. The mounting assembly is arranged between the heat dissipation assembly and the nozzle assembly, and is configured to connect the nozzle assembly and the heat dissipation assembly.

### FIELD

The present disclosure relates to field of 3D printing, and in particular to an extruder nozzle and a 3D printing device using the same.

### BACKGROUND

3D printing technology is a rapid prototyping technology that creates three-dimensional objects by printing layers of materials based on digital model files, using special wax, powdered metal, or plastic as bondable materials. Fused deposition modeling is one of the main 3D printing technologies. This technology involves heating and melting filament materials, extruding them through a nozzle, and depositing them on a forming platform or previously solidified material layers. The material solidifies when the temperature drops below the filament's solidification temperature, eventually forming the object. Based on the 3D printing process, zoned temperature control of consumable materials at different positions during the melting and extrusion process helps improve 3D printing effects. How to provide a structure that can effectively meet this requirement is a consideration for those skilled in the art.

Thus, there is room for improvement within the art.

### BRIEF DESCRIPTION OF THE DRAWINGS

Many aspects of the disclosure can be better understood with reference to the following drawings. The drawings in the following description are some embodiments of the present disclosure. For those of ordinary skill in the art, other drawings can be obtained based on these drawings without creative work.

FIG. 1 is a structural diagram of an extruder nozzle according to embodiments of the present application.

FIG. 2 is a side view of an extruder nozzle according to an embodiment of the present application.

FIG. 3 is a partial perspective view of an extruder nozzle according to an embodiment of the present application.

FIG. 4 is an exploded perspective view of an extruder nozzle according to an embodiment of the present application.

FIG. 5 is a sectional view of an extruder nozzle according to an embodiment of the present application.

FIG. 6 is a structural diagram of an extruder nozzle according to another embodiment of the present application.

FIG. 7 is a structural diagram of an extruder nozzle according to another embodiment of the present application.

FIG. 8 is a sectional view of an extruder nozzle according to another embodiment of the present application.

FIG. 9 is a structural diagram of an extruder nozzle according to another embodiment of the present application.

FIG. 10 is a perspective view of a 3D printing device according to an embodiment of the present application.

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it in one embodiment indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms “and/or” used herein includes any and all combinations of one or more of associated listed items.

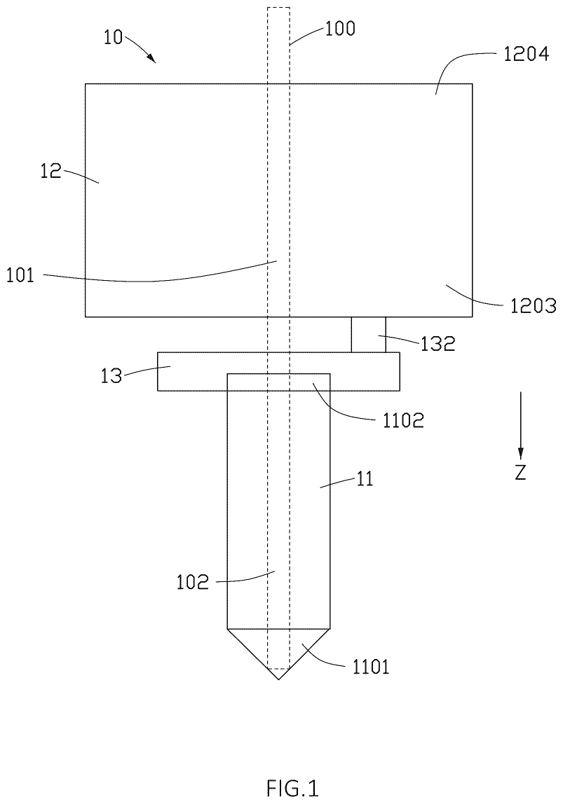

Referring to FIG. 1, embodiments of the present application provide an extruder nozzle 10, the extruder nozzle 10 includes a nozzle assembly 11, a heat dissipation assembly 12, and a mounting assembly 13. The heat dissipation assembly 12 is spaced apart from the nozzle assembly 11, and the mounting assembly 13 is configured to connect the nozzle assembly 11 and the heat dissipation assembly 12.

In an embodiment, the extruder nozzle 10 further includes a transmission channel 100, the transmission channel 100 extends along a first direction Z and is configured to transmit consumable material. The transmission channel 100 includes an upstream portion 101 and a downstream portion 102 arranged along the first direction Z. The nozzle assembly 11 is thermally coupled with the downstream portion 102 and is configured to heat the consumable material in the transmission channel 100. The heat dissipation assembly 12 is thermally coupled with the upstream portion 101, and the heat dissipation assembly 12 is spaced apart from the nozzle assembly 11 along the first direction Z, with a part of the transmission channel 100 arranged between the nozzle assembly 11 and the heat dissipation assembly 12. The mounting assembly 13 is arranged between the heat dissipation assembly 12 and the nozzle assembly 11.

The extruder nozzle 10 provided by the present application achieves the nozzle assembly 11 and the heat dissipation assembly 12 to provide different temperature control solutions for different portions of the consumable material in the transmission channel 100, improving heat treatment effect on the consumable material and enhancing the 3D printing effect.

In an embodiment, the nozzle assembly 11 may have a heating function or be configured to be thermally coupled with other structures having heating function (such as heating assembly 14), to melt and extrude the consumable material in the nozzle assembly 11. The heat dissipation assembly 12 may be thermally coupled with the consumable material and/or the nozzle assembly 11, configured to adjust and improve the heat dissipation effect of part of the consumable material out of the nozzle assembly 11, control temperature of the part of the consumable material, and prevent issues such as excessive expansion or premature melting of the consumable material causing blockage.

In an embodiment, the transmission channel 100 may be a tube with through-hole, or through-holes formed in the nozzle assembly 11 and/or the heat dissipation assembly 12, or a combination of both approaches, which is not limited by the present application. In one embodiment, the transmission channel 100 is illustrated as a metal pipe extending along an axial direction of the extruder nozzle 10, with a through-hole along the axial direction inside, configured to transport the consumable material through the transmission channel 100 under drive. In other embodiments, the transmission channel 100 may be formed by connecting pipes that are respectively connected to the nozzle assembly 11 and the heat dissipation assembly 12.

In an embodiment, the nozzle assembly 11 is spaced apart from the heat dissipation assembly 12 along a first direction Z, and the heat dissipation assembly 12 may be arranged between the nozzle assembly 11 and the heat dissipation assembly 12 along the first direction Z, connecting the nozzle assembly 11 and the heat dissipation assembly 12. The transmission channel 100 may extend along the first direction Z, facilitating the consumable material to pass through the heat dissipation assembly 12 and the nozzle assembly 11 sequentially along the first direction Z, and finally be extruded in a molten state at an end of the nozzle assembly 11.

Embodiments of the present application introduce a first direction Z, a second direction X, and a third direction Y for description, where the first direction Z, second direction X, and third direction Y are three non-parallel directions in a spatial coordinate system. In some embodiments, these directions are described as three mutually perpendicular reference directions in a three-dimensional Cartesian coordinate system. The directions shown in embodiments of the present application are configured to help understand the relative positions of various components but do not limit their specific directions.

The first direction Z may be the extending direction of the transmission channel 100, and the portion of the transmission channel 100 in the extruder nozzle 10 may be designed to be linear (as shown in FIG. 1). The consumable material may be filament material, and the transmission channel 100 is not limited to a linear shape and may also be curved, with positions of the nozzle assembly 11, heat dissipation assembly 12, and mounting assembly 13 changing accordingly.

In an embodiment, the nozzle assembly 11 includes a first end portion 1101 and a second end portion 1102. The first end portion 1101 is configured to facilitate the consumable material to be extruded, and the second end portion 1102 is configured to facilitate the consumable material to enter the nozzle assembly 11. The first end portion 1101 and the second end portion 1102 are spaced apart along the first direction Z, and the mounting assembly 13 is arranged on the second end portion 1102.

The first end portion 1101 is an extrusion end portion of the nozzle assembly 11, and the second end portion 1102 is another end away from the extrusion end portion of the nozzle assembly 11, where the mounting assembly 13 is disposed on the other end of the nozzle assembly 11 away from the material extrusion end portion.

In an embodiment, the heat dissipation assembly 12 includes a third end portion 1203 and a fourth end portion 1204. The third end portion 1203 is configured to connect with the mounting assembly 13, and the fourth end portion 1204 is configured to facilitate the consumable material to enter the heat dissipation assembly 12. The third end portion 1203 and the fourth end portion 1204 are spaced apart along the first direction Z.

The fourth end portion 1204 is a material feeding end portion of the heat dissipation assembly 12, and the third end portion 1203 is another end away from the material feeding end portion of the heat dissipation assembly 12, where the mounting assembly 13 connects to the other end of the heat dissipation assembly 12 away from the material feeding end portion.

In one embodiment, the second end portion 1102 is spaced apart from the third end portion 1203 to expose a section of the transmission channel 100, to maximize isolation of heat transfer between the upstream portion 101 and the downstream portion 102.

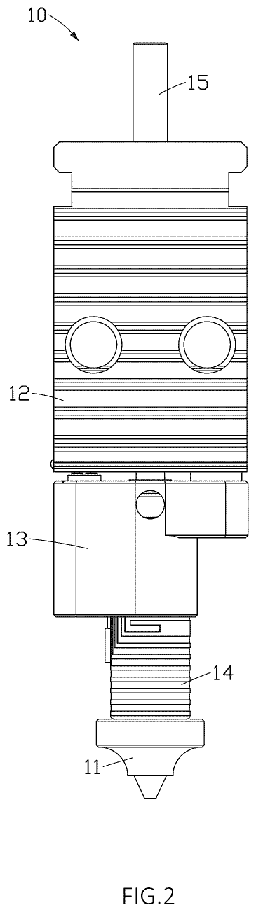

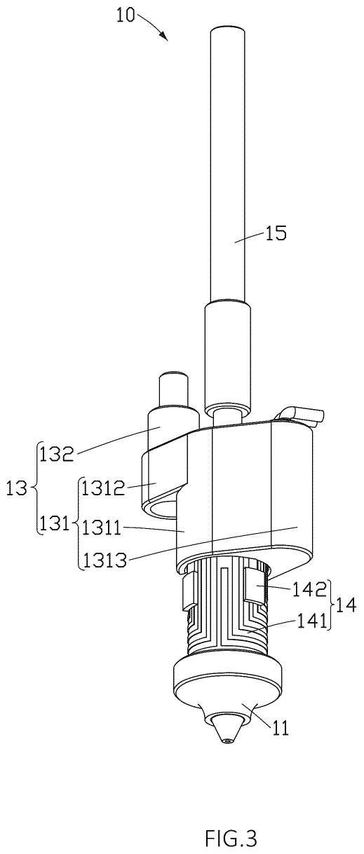

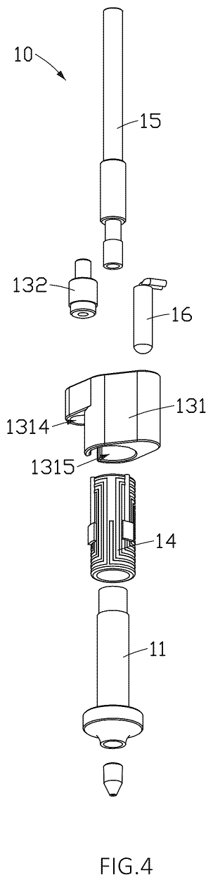

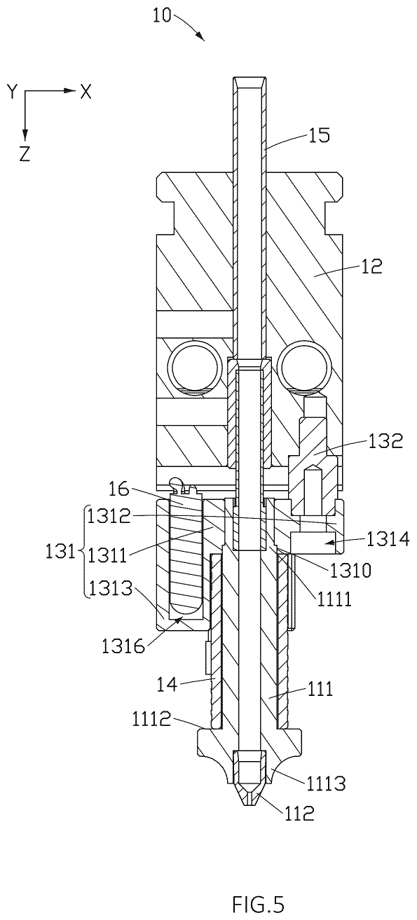

Further referring to FIG. 2 to FIG. 5, which show diagrams of an extruder nozzle 10 according to an embodiment of the present application. In one embodiment, the mounting assembly 13 includes one or more connecting post 132, and the nozzle assembly 11 is connected to the heat dissipation assembly 12 through the connecting post 132.

In one embodiment, the heat dissipation assembly 12 may be a heat dissipation structure with multiple heat dissipation fins. The transmission channel 100 penetrates through the heat dissipation assembly 12, and the heat dissipation assembly 12 improves the heat dissipation efficiency of a portion of the consumable material in the transmission channel 100 corresponding to the heat dissipation assembly 12, preventing overheating of the portion of the consumable material. The nozzle assembly 11 is spaced apart from the heat dissipation assembly 12. The nozzle assembly 11 may generate heat by itself or may be configured to mount a heating assembly 14. The transmission channel 100 penetrates through the heat dissipation assembly 12, and the nozzle assembly 11 is able to heat a portion of the consumable material corresponding to the nozzle assembly 11 to melt it and enable it to be extruded for printing. In one embodiment, the heat dissipation assembly 12 and the nozzle assembly 11 may have different set temperatures. To improve the overall thermal efficiency of the extruder nozzle 10, the heat dissipation assembly 12 and the nozzle assembly 11 are spaced apart. Meanwhile, to ensure the overall connection effect of the extruder nozzle 10, the mounting assembly 13 may be set up to assemble the heat dissipation assembly 12 and the nozzle assembly 11.

In an embodiment, the mounting assembly 13 further includes a connecting portion 131, the connecting portion 131 is sleeved and connected to the nozzle assembly 11, and the connecting portion 131 is disposed on the second end portion 1102. The connecting post 132 connects the heat dissipation assembly 12 and the connecting portion 131.

In an embodiment, the extruder nozzle 10 further includes a heating assembly 14, which comprises a heating ring 141. The heating ring 141 is sleeved around an outer side of the nozzle assembly 11 such that the transmission channel 100 penetrates through the heating ring 141 along the first direction Z, and the mounting assembly 13 abuts against the heating ring 141 to fix the heating ring 141.

In an embodiment, the connecting portion 131 includes a first step structure 1310, and the connecting portion 131 is sleeved around the outer side of the nozzle assembly 11 and the heating ring 141, with the first step structure 1310 abutting against the heating ring 141. The nozzle assembly 11 includes a second step structure 1112, and an end of the heating ring 141 away from the first step structure 1310 is supported on the second step structure 1112.

In one embodiment, the nozzle assembly 11 includes a transmission portion 111 and a nozzle portion 112 connected to the transmission portion 111, with the transmission channel 100 penetrating through both the transmission portion 111 and the nozzle portion 112. The transmission portion 111 is positioned on a side of the nozzle assembly 11 closer to the heat dissipation assembly 12 and is configured to connect with the mounting assembly 13. The nozzle portion 112 is arranged on a side of the nozzle assembly 11 away from the heat dissipation assembly 12 and is configured to narrow the transmission channel 100 for extruding the consumable material. The transmission channel 100 penetrates through the transmission portion 111 and the nozzle portion 112 sequentially along the first direction Z.

In one embodiment, the transmission portion 111 and the nozzle portion 112 may be detachably connected. For example, the transmission portion 111 may be made of material with good thermal conductivity, while the nozzle portion 112 may be made of material with high hardness, and the transmission portion 111 and the nozzle portion 112 are detachably connected through threaded engagement. In other embodiments, the transmission portion 111 and the nozzle portion 112 may be an integrally formed structure. For example, the transmission portion 111 and the nozzle portion 112 are formed through integral die-casting or milling processes.

In one embodiment, the transmission portion 111 extends along the first direction Z and may be made of material with high thermal conductivity coefficient and/or good heat conduction effect (such as copper). The transmission channel 100 includes a through-hole penetrating along the first direction Z inside, the through-hole is configured for transmitting consumable material and constitutes the transmission channel 100. The consumable material in the through-hole may be heated through thermal coupling with the transmission portion 111. In other embodiments, the transmission portion 111 may be other shapes, and/or the transmission channel 100 may be formed by inserting a tube in the transmission portion 111.

In one embodiment, an outer diameter of the transmission portion 111 on a side connecting to the mounting assembly 13 is smaller than an outer diameter on a side connecting to the nozzle portion 112, forming a second step structure 1112 on the transmission portion 111, the second structure 1112 is configured to support the heating ring 141 sleeved around the outer side of the transmission portion 111. In one embodiment, the transmission portion 111 includes a throat tube connecting end portion 1111 and a nozzle connecting end portion 1113 spaced apart along the first direction Z. The throat tube connecting end portion 1111 may be generally cylindrical, the nozzle connecting end portion 1113 may be generally frustoconical. The connection between the throat tube connecting end portion 1111 and the nozzle connecting end portion 1113 forms the second step structure 1112 due to their different outer diameters, facilitating the heating ring 141 to be fitted around the outer side of the throat tube connecting end portion 1111 and abut against a bottom surface of the nozzle connecting end portion 1113. The nozzle portion 112 connects to a side of the nozzle connecting end portion 1113 away from the throat tube connecting end portion 1111, and the nozzle portion 112 and the nozzle connecting end portion 1113 may generally form a conical shape.

In one embodiment, the heating assembly 14 includes a heating ring 141 and one or more conductive member 142. The conductive member 142 is electrically connected to the heating ring 141, the heating ring 141 is able to convert electrical energy into thermal energy and generate heat. The heating ring 141 may be a ceramic heating ring 141, and the generally cylindrical heating ring 141 may be fitted around an outer side of the throat tube connecting end portion 1111 and supported by the nozzle connecting end portion 1113 through the second step structure 1112. The conductive member 142 is connected to an outer side of the heating ring 141 away from the throat tube connecting end portion 1111. In one embodiment, there can be multiple conductive members 142, each electrically connected to the ceramic heating ring 141. The conductive members 142 conduct electricity to the heating ring 141, causing the heating ring 141 to heat up, and the heat generated by the heating ring 141 is transferred through the transmission portion 111 to the consumable material inside the transmission portion 111.

In other embodiments, the nozzle assembly 11 may not have a separate heating assembly 14, as the heating assembly 14 may be integrated into the nozzle assembly 11. Alternatively, in other embodiments, the heating ring 141 may have other shapes or be made of other types of heating materials.

In an embodiment, the connecting portion 131 includes a first portion 1311, a second portion 1312, and a third portion 1313, with the second portion 1312 and the third portion 1313 each connected to the first portion 1311.

In an embodiment, the first portion 1311 includes an assembling cavity 1314 penetrating along the first direction Z. The second portion 1312 includes a mounting cavity 1315 penetrating along the first direction Z. The third portion 1313 includes a receiving groove 1316.

In an embodiment, the assembling cavity 1314 is configured to receive the nozzle assembly 11, the mounting cavity 1315 is configured to receive the connecting post 132, and the receiving groove 1316 is configured to receive a sensor 16, with the mounting cavity 1315 and the receiving groove 1316 being spaced apart.

In one embodiment, the assembling cavity 1314 extends along the first direction Z, with a smaller inner diameter closer to the heat dissipation assembly 12 and a larger inner diameter away from the heat dissipation assembly 12, forming a first step structure 1310 inside the first portion 1311. When the connecting portion 131 is fitted around the outer side of the transmission portion 111 and the heating ring 141, a wall of the first portion 1311 is positioned on an outer side of the heating ring 141 away from the transmission portion 111 to limit the heating ring 141, and the first step structure 1310 abuts and presses against the end of the heating ring 141 away from the nozzle connecting end portion 1113, thereby cooperating with the second step structure 1112 to mount the heating ring 141 on the transmission portion 111. The first portion 1311 is detachably connected to the throat tube connecting end portion 1111 of the transmission portion 111, with connection methods including but not limited to snap-fit connection, threaded connection, and other known and feasible methods (not shown in figures).

In one embodiment, the second portion 1312 extends from the first portion 1311 towards the side away from the transmission channel 100, and the mounting cavity 1315 is formed in the third portion 1313. The mounting cavity 1315 may be either a structure penetrating along the first direction Z or a blind hole structure with an opening towards a side where the heat dissipation assembly 12 is arranged along the first direction Z. One end of the connecting post 132 is positioned in the mounting cavity 1315 and connected to the second portion 1312 through snap-fit, threaded connection, abutting restriction, or other means; and another end of the connecting post 132 is connected to the heat dissipation assembly 12 through snap-fit, threaded connection, abutting restriction, or other means. The heat dissipation assembly 12 connects to the connecting post 132, the connecting post 132 connects to the connecting portion 131, and the connecting portion 131 connects to the nozzle assembly 11, achieving the connection between the heat dissipation assembly 12 and the nozzle assembly 11.

In one embodiment, the third portion 1313 extends from the first portion 1311 towards the side away from the transmission channel 100, and a receiving groove 1316 is formed in the third portion 1313, the receiving groove 1316 is configured to receive a sensor 16 (such as a temperature sensor or infrared sensor). The sensor 16 is positioned close to the heating assembly 14 and nozzle assembly 11 through placement in the receiving groove 1316, configured for sensing a temperature of the heating assembly 14 and/or nozzle assembly 11 to monitor the temperature of the melted consumable material.

In one embodiment, the second portion 1312 and the third portion 1313 are disposed on opposite sides of the first portion 1311. A length of the third portion 1313 along the first direction Z may be approximately the same as a length of the first portion 1311, while a length of the second portion 1312 along the first direction Z may be shorter than a length of the third portion 1313 and a length the first portion 1311, which helps reduce the volume and weight of the connecting portion 131, contributing to the lightweight design of the extruder nozzle 10.

In one embodiment, the connecting portion 131 may be an integral structure, with the first portion 1311, second portion 1312, and third portion 1313 being different regions divided according to their functions, and these portions are actually integrally formed. In other embodiments, the connecting portion 131 may be a separated structure, with the first portion 1311, second portion 1312, and third portion 1313 being detachably connected to each other.

In one embodiment, the second portion 1312 and the third portion 1313 may be respectively disposed on opposite sides of the first portion 1311 along the second direction X. In other embodiments, the second portion 1312 and the third portion 1313 may be arranged in other configurations relative to the first portion 1311.

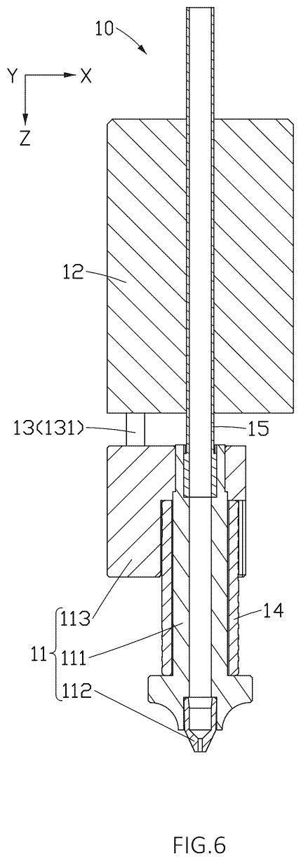

Further referring to FIG. 6, which shows a diagram of another embodiment of the extruder nozzle 10 provided by the present application. In one embodiment, the mounting assembly 13 includes a connecting post 132, and the nozzle assembly 11 is connected to the heat dissipation assembly 12 through the connecting post 132.

In an embodiment, the nozzle assembly 11 further includes a protruding portion 113, and the connecting post 132 connects the protruding portion 113 and the heat dissipation assembly 12.

In an embodiment, the extruder nozzle 10 further includes a connecting tube 15, the connecting tube 15 is configured to transmit consumable material, and the heat dissipation assembly 12 is fitted around an outer side of the connecting tube 15.

In an embodiment, the protruding portion 113 is connected to the transmission portion 111, one end of the connecting tube 15 extends into the transmission portion 111 and abuts against the nozzle assembly 11, and the connecting tube 15 is spaced apart from the protruding portion 113.

In an embodiment, the transmission channel 100 penetrates through the transmission portion 111 along the first direction Z, and the protruding portion 113 and the transmission portion 111 are arranged side by side along the first direction Z and connected. The transmission portion 111 extends along the first direction Z towards the side away from the heat dissipation assembly 12, and the protruding portion 113 connects with the transmission portion 111 and extends towards the side away from the transmission channel 100. In one embodiment, the protruding portion 113 is a block-shaped protrusion structure positioned on one side of the transmission portion 111 along the second direction X. In other embodiments, the protruding portion 113 may have other shapes.

In one embodiment, one end of the transmission portion 111 is connected to the nozzle portion 112, and the other end of the transmission portion 111is connected to the protruding portion 113. The connecting post 132 connects to the protruding portion 113 to achieve the connection between the nozzle assembly 11 and the heat dissipation assembly 12.

In one embodiment, the protruding portion 113 and the transmission portion 111 are separate structures, with the heating assembly 14 coupled between the protruding portion 113 and the transmission portion 111. In other embodiments, the transmission portion 111 and the protruding portion 113 may be an integral structure, and the heating assembly 14 may be integrated into the nozzle assembly 11 or installed through other mounting methods. The sensor 16 may be omitted or installed at other locations on the nozzle assembly 11 and/or heating assembly 14 through other methods.

In one embodiment, the connecting tube 15 may be configured to form the transmission channel 100, and the connecting tube 15 connects to and penetrates through the heat dissipation assembly 12. One end of the connecting tube 15 extends into the transmission portion 111 and communicates with the channel inside the transmission portion 111 to transmit consumable material, while the connecting tube 15 and the transmission portion 111 are connected through snap-fit, threaded connection, abutting restriction, or other means. The heat dissipation assembly 12 and the nozzle assembly 11 are connected through a spaced connecting post 132 and a connecting tube 15, making the connection between the heat dissipation assembly 12 and the nozzle assembly 11 more stable.

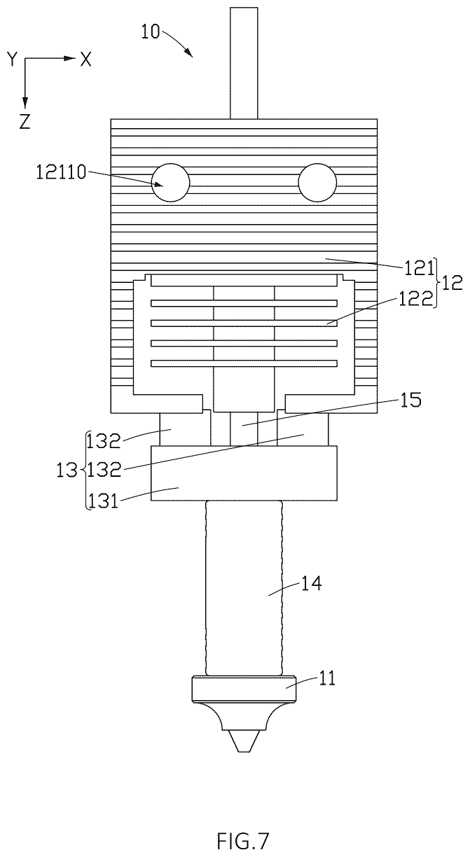

Further referring to FIG. 7 to FIG. 9, which show diagrams of other embodiments of the extruder nozzle 10 provided by the present application. In one embodiment, the mounting assembly 13 includes a connecting portion 131 and multiple connecting posts 132, with the connecting portion 131 sleeved on the nozzle assembly 11, and multiple connecting posts 132 connecting both the heat dissipation assembly 12 and the connecting portion 131.

In an embodiment, the connecting portion 131 is disposed at the end of the nozzle assembly 11 closer to the heat dissipation assembly 12, the connecting posts 132 connect to the connecting portion 131 and protrude towards the heat dissipation assembly 12, and all of the multiple connecting posts 132 are spaced apart from the transmission channel 100.

In one embodiment, the nozzle assembly 11 may generate heat by itself or may be configured to mount a heating assembly 14. The nozzle assembly 11 is configured to facilitate the transmission channel 100 to penetrate through it, and the nozzle assembly 11 may heat the portion of consumable material corresponding to the nozzle assembly 11 to melt the portion of consumable material and enable the portion of consumable material to be extruded for printing. The heat dissipation assembly 12 and the nozzle assembly 11 may have different set temperatures. To improve the overall thermal efficiency of the extruder nozzle 10, the heat dissipation assembly 12 and the nozzle assembly 11 are spaced apart, and to ensure the overall connection effect of the extruder nozzle 10, the spaced heat dissipation assembly 12 and nozzle assembly 11 are connected through the mounting assembly 13. The connecting portion 131 and the nozzle assembly 11 are connected through snap-fit, threaded connection, abutting restriction, or other means, and each of the multiple connecting posts 132 connects to both the connecting portion 131 and the heat dissipation assembly 12.

The structure and function of the nozzle assembly 11 and heating assembly 14 in the embodiments of FIG. 7 to FIG. 9 may be the same as or similar to those of the nozzle assembly 11 and heating assembly 14 in previous embodiments, which will not be repeated here.

In an embodiment, the heat dissipation assembly 12 includes a heat dissipation connecting frame 121 and a heat dissipation member 122, the heat dissipation connecting frame 121 connects to the multiple connecting posts 132, and the heat dissipation member 122 connects to the heat dissipation connecting frame 121. Both the heat dissipation connecting frame 121 and heat dissipation member 122 may be provided with heat dissipation fins to enhance the heat dissipation effect.

In one embodiment, the heat dissipation connecting frame 121 includes a first heat dissipation portion 1211 and a second heat dissipation portion 1212 connected to the first heat dissipation portion 1211. The first heat dissipation portion 1211 is positioned at an end of the heat dissipation connecting frame 121 away from the nozzle assembly 11, and the second heat dissipation portion 1212 is positioned at an end of the heat dissipation connecting frame 121 closer to the nozzle assembly 11, the second heat dissipation portion 1212 is configured to connect with multiple connecting posts 132. The first heat dissipation portion 1211 includes heat dissipation connecting holes 12110, the heat dissipation connecting holes 12110 is configured to receive connecting elements such as bolts, achieving the first heat dissipation portion 1211 to externally mount a cooling unit (such as an air cooling unit, not shown in figures) to enhance heat dissipation effect. The second heat dissipation portion 1212 includes a heat dissipation cavity 12120, a solid frame of the second heat dissipation portion 1212 is configured to connect the multiple connecting posts 132, and the heat dissipation cavity 12120 is configured to receive the heat dissipation member 122, the heat dissipation member 122 may directly contact the transmission channel 100 to enhance heat dissipation effect.

The cooling unit externally mounted on the first heat dissipation portion 1211 may be positioned corresponding to the heat dissipation cavity 12120 of the second heat dissipation portion 1212, enhancing the heat dissipation effect of the heat dissipation member 122 positioned in the heat dissipation cavity 12120.

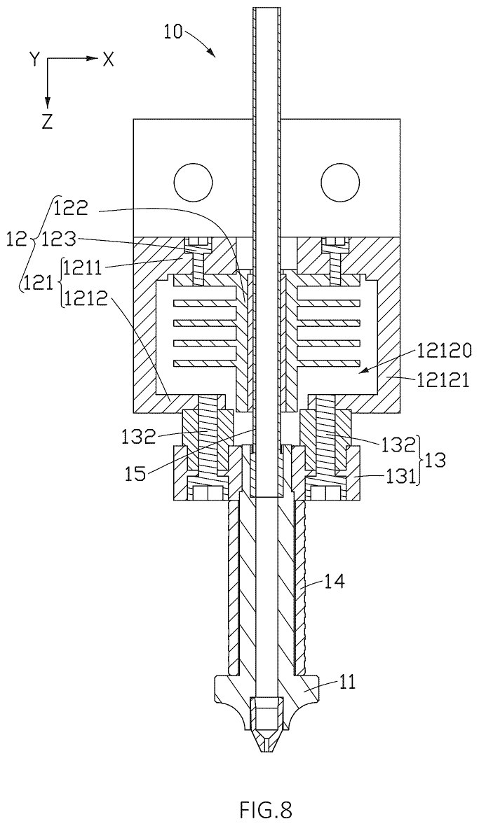

Further referring to FIG. 7 and FIG. 8, in one embodiment, the first heat dissipation portion 1211 is generally an integral structure, and the heat dissipation member 122 is connected to the first heat dissipation portion 1211 through heat dissipation connecting members 123, the heat dissipation connecting members 123 may be bolts. The second heat dissipation portion 1212 including two connecting arms 12121 spaced apart along the second direction X, forming the heat dissipation cavity 12120 between the two connecting arms 12121. Ends of the connecting arms 12121 away from the nozzle assembly 11 connect to the first heat dissipation portion 1211, while ends of the connecting arms 12121 closer to the nozzle assembly 11 connect to the mounting assembly 13. The two connecting arms 12121 are respectively disposed on both sides of the heat dissipation cavity 12120 along the second direction X, with each connecting arm 12121 connecting to one connecting post 132, and the two connecting posts 132 are respectively positioned on both sides of the transmission channel 100 along the second direction X.

In one embodiment, the connecting portion 131 of the mounting assembly 13 may be generally plate-shaped, with two connecting posts 132 spaced apart and connected to both sides of the connecting portion 131 along the second direction X.

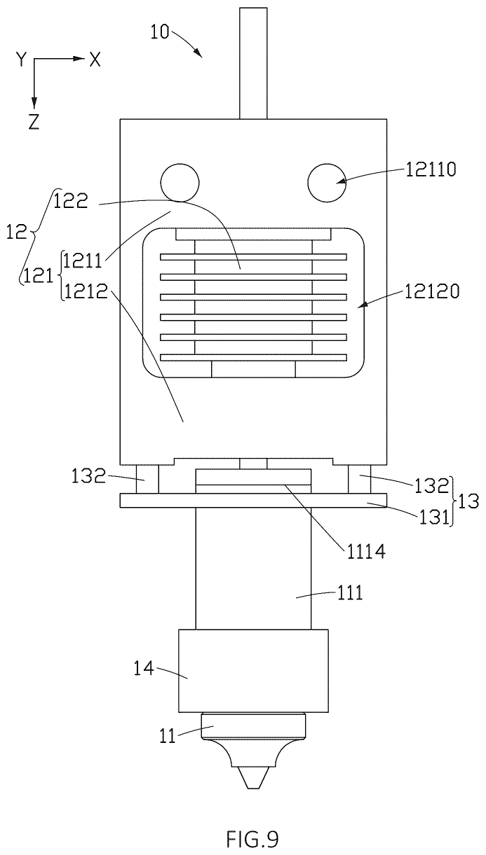

Further referring to FIG. 9, in one embodiment, both the first heat dissipation portion 1211 and second heat dissipation portion 1212 are generally integral structures, with the heat dissipation cavity 12120 formed by hollowing out the second heat dissipation portion 1212, and a side of the second heat dissipation portion 1212 away from the first heat dissipation portion 1211 includes a connecting structure.

In one embodiment, the nozzle assembly 11 includes a groove 1114, the groove 1114 is recessed towards the transmission channel 100. The connecting portion 131 may be plate-shaped, the connecting portion 131 is fitted around the outer side of the nozzle assembly 11, and snap-fitted with the nozzle assembly 11 through a slotted structure. There are four connecting posts 132, with each connecting post 132 connected to one corner of the connecting portion 131, two spaced connecting posts 132 are arranged along both the second direction X and the third direction Y.

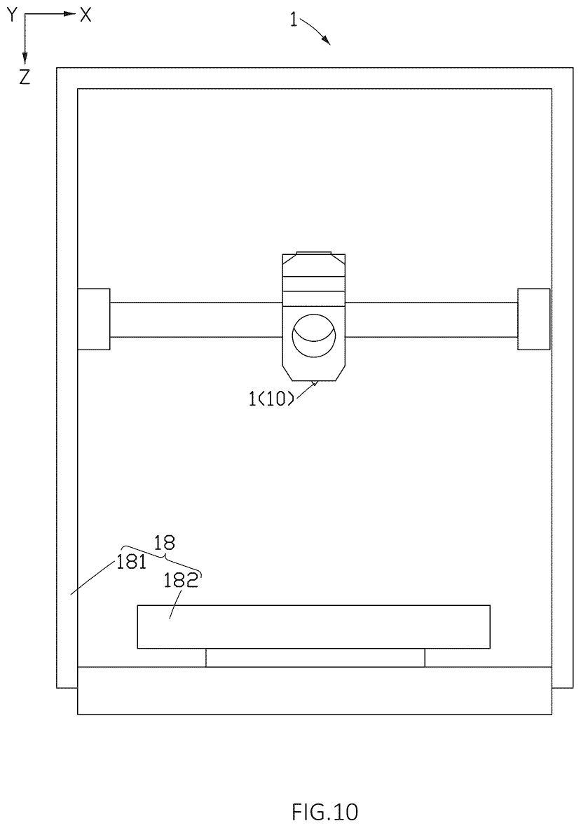

Further referring to FIG. 10, embodiments of the present application further provide a 3D printing device 1, the 3D printing device 1 includes a main body structure 18 and any of the extruder nozzle 10 from the previous embodiments, the extruder nozzle 10 is connected to the main body structure 18.

In one embodiment, the main body structure 18 includes a support frame 181 and a forming platform 182, the extruder nozzle 10 and the forming platform 182 are respectively connected to the support frame 181. The extruder nozzle 10 and the forming platform 182 is able to move relative to each other to achieve 3D printing.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An extruder nozzle, comprising:
a transmission channel, extending along a first direction and configured to transmit consumable material, the transmission channel comprising an upstream portion and a downstream portion arranged along the first direction;
a nozzle assembly, thermally coupled with the downstream portion and configured to heat the consumable material in the transmission channel;
a heat dissipation assembly, thermally coupled with the upstream portion, wherein the heat dissipation assembly is spaced apart from the nozzle assembly along the first direction, and the transmission channel is arranged between the nozzle assembly and the heat dissipation assembly; and
a mounting assembly, arranged between the heat dissipation assembly and the nozzle assembly, and configured to connect the nozzle assembly and the heat dissipation assembly.

2. The extruder nozzle according to claim 1, wherein the mounting assembly comprises a connecting post, and the nozzle assembly is connected to the heat dissipation assembly through the connecting post.

3. The extruder nozzle according to claim 2, wherein the mounting assembly further comprises:
a connecting portion, the connecting portion is fitted and connected to the nozzle assembly,
wherein the connecting post connects the heat dissipation assembly and the connecting portion.

4. The extruder nozzle according to claim 3, wherein the nozzle assembly comprises:
a first end portion, configured to facilitate the consumable material to be extruded; and
a second end portion, configured to facilitate the consumable material to enter the nozzle assembly,
wherein the first end portion is spaced apart from the second end portion along the first direction, and the connecting portion is arranged on the second end portion.

5. The extruder nozzle according to claim 3, wherein the connecting portion comprises:
an assembling cavity, configured to receive the nozzle assembly;
a mounting cavity, configured to receive the connecting post; and
a receiving groove, configured to receive a sensor, wherein the mounting cavity is spaced apart from the receiving groove along a second direction, and the first direction intersects with the second direction.

6. The extruder nozzle according to claim 5, wherein the connecting portion comprises:
a first portion, comprising the assembling cavity penetrating along the first direction;
a second portion, connected to the first portion, and comprising the mounting cavity penetrating along the first direction; and
a third portion, comprising the receiving groove,
wherein the second portion and the third portion are respectively connected to the first portion.

7. The extruder nozzle according to claim 2, wherein the nozzle assembly comprises:
a protruding portion, connecting the protruding portion and the heat dissipation assembly.

8. The extruder nozzle according to claim 7, wherein the nozzle assembly further comprises:
a transmission portion, wherein the transmission channel penetrates through the transmission portion along the first direction;
wherein the protruding portion and the transmission portion are arranged side by side along the first direction and connected to each other, and the transmission portion extends along the first direction towards a side away from the heat dissipation assembly.

9. The extruder nozzle according to claim 7, wherein the extruder nozzle further comprises:
a connecting tube, configured to transmit consumable material, wherein the heat dissipation assembly is fitted around an outer side of the connecting tube;
wherein the nozzle assembly further comprises a transmission portion connected to the protruding portion, one end of the connecting tube extends into the transmission portion and abuts against the nozzle assembly, and the connecting tube is spaced apart from the protruding portion.

10. The extruder nozzle according to claim 1, wherein the heat dissipation assembly comprises:
a third end portion, configured to connect with the mounting assembly;
a fourth end portion, configured to facilitate the consumable material to enter the heat dissipation assembly;
wherein the third end portion is spaced apart from the fourth end portion along the first direction.

11. The extruder nozzle according to claim 1, wherein the extruder nozzle further comprises:
a heating assembly, comprising a heating ring;
wherein the heating ring is sleeved on an outer side of the nozzle assembly, the transmission channel penetrates through the heating ring along the first direction, and the mounting assembly abuts against the heating ring.

12. The extruder nozzle according to claim 11, wherein:
the mounting assembly comprises a connecting portion comprising a first step structure, wherein the connecting portion is sleeved around the outer side of the nozzle assembly and the heating ring, the first step structure abuts against the heating ring;
the nozzle assembly comprises a second step structure, wherein an end of the heating ring away from the first step structure is supported on the second step structure.

13. The extruder nozzle according to claim 1, wherein the mounting assembly comprises:
a connecting portion, sleeved on the nozzle assembly; and
multiple connecting posts, connecting the heat dissipation assembly and the connecting portion, and spaced apart from the transmission channel.

14. The extruder nozzle according to claim 13, wherein the connecting portion is disposed at the end of the nozzle assembly closer to the heat dissipation assembly, the multiple connecting posts connect to the connecting portion and protrude towards the heat dissipation assembly.

15. The extruder nozzle according to claim 13, wherein the heat dissipation assembly comprises:
a heat dissipation connecting frame connected to the multiple connecting posts; and
a heat dissipation member connected to the heat dissipation connecting frame.

16. The extruder nozzle according to claim 15, wherein the heat dissipation connecting frame comprises a first heat dissipation portion and a second heat dissipation portion connected to the first heat dissipation portion, the second heat dissipation portion is configured to connect with multiple connecting posts.

17. The extruder nozzle according to claim 16, wherein the second heat dissipation portion comprises a heat dissipation cavity, the heat dissipation cavity is configured to receive the heat dissipation member.

18. The extruder nozzle according to claim 6, wherein the second portion and the third portion are disposed on opposite sides of the first portion, a length of the third portion along the first direction is the same as a length of the first portion, a length of the second portion along the first direction is shorter than a length of the third portion.

19. A 3D printing device, comprising:
a main body structure; and
the extruder nozzle of claim 1, wherein the extruder nozzle is connected to the main body structure.

20. The 3D printing device according to claim 19, wherein the main body structure comprises a support frame and a forming platform, the extruder nozzle and the forming platform are respectively connected to the support frame.
